(19) United States
(12) Patent Application Publication
(10) Pub. No.: US 2002/0131638 A1
(43) Pub. Date: Sep. 19, 2002

(54) Apparatus and method for boundary detection in vector sequences and edge detection in color image signals

(75) Inventors: Haiyan He, Sunnyvale, CA (US); Johan Janssen, South Salem, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/004,473

(22) Filed: Nov. 2, 2001

Related U.S. Application Data
(60) Provisional application No. 60/260,844, filed on Jan. 10, 2001.

(51) Int. Cl. G06K 9/00; G06K 9/48; G06K 9/34

(52) U.S. Cl. 382/197; 382/164; 382/199

(57) ABSTRACT

There is disclosed an apparatus and method for boundary detection in vector sequences and edge detection in color image signals. A boundary detection controller analyzes a vector sequence that represents a signal. A frequency dependent function is used to calculate a modified first order difference (MFD) of the vector act sequence, first as a vector quantity, then as a scalar quantity. A local maximum of the MFD scalar quantity that is greater than a predetermined threshold value identifies a boundary location. The boundary detection controller also analyzes luminance and chrominance portions of a color image signal to locate luminance edges and chrominance edges in a color image.

### TECHNICAL FIELD OF THE INVENTION

The present invention is directed, in general, to signal processing and, more specifically, to an apparatus and method for boundary detection in vector sequences and edge detection in color image signals.

### BACKGROUND OF THE INVENTION

Each pixel in a color image may be represented by a three dimensional vector in a color space. A color space may be represented by a number of different coordinate systems.

For example, well known color space coordinates systems include the (Y, U, V) system, the (R, G, B) system, the (L, a, b) system, the (X, Y, Z) system, and the (I, H, S) system. Of these systems, the (I, H, S) system is the one most closely related to human perception.

An input video signal is normally represented in the (R,G,B) system or in the (Y, U, V) system. In the (Y, U, V) system, the letter Y represents the luminance (brightness) portion of the video signal. The luminance Y is derived from the red, green, and blue color signals of a video signal. In NTSC systems the value of the luminance Y is given by the relationship Y=0.30 Red+0.59 Green+0.11 Blue. The letter U represents a chrominance portion of the video signal measured by a color difference of R−Y where R represents the red video signal. U is derived from the red, green, and blue color signals of a video signal. The value of U is given by the relationship U=0.70 Red −0.59 Green −0.11 Blue. Lastly, The letter V represents a chrominance portion of the video signal measured by a color difference of B−Y where B represents the blue video signal. V is derived from the red, green, and blue color signals of a video signal. The value of V is given by the relationship V=0.89 Blue −0.59 Green −0.30 Red.

Prior art edge detection algorithms typically utilize only the luminance information (i.e., information relating to the value of the luminance signal Y). However, it is possible that two neighboring objects in a color image may have different colors but still have similar values of luminance Y. Therefore, edge detection algorithms that use only luminance values do not always work.

For applications like image enhancement, image segmentation, and identification of image objects, it is important to have accurate edge information. In addition, for applications like “color transient improvement” it is important to be able to detect a chrominance edge within a color image signal.

Therefore, there is a need in the art for an improved apparatus and method for accurately detecting edges in color image signals. There is also a need in the art for an apparatus and method that uses both luminance values and chrominance values to accurately detect edges in color image signals. There is also a need in the art for an apparatus and method for accurately detecting chrominance edges in color image signals.

### SUMMARY OF THE INVENTION

To address the above mentioned deficiencies of the prior art, it is a primary object of the present invention to provide an apparatus and method for detecting a boundary in a vector sequence that represents a signal.

It is also an object of the present invention to provide an apparatus and method for a detecting an edge in a color image signal.

The present invention comprises a boundary detection controller that is capable of analyzing a vector sequence \vec{A}(n) that represents a signal. The boundary detection controller uses a frequency dependent function to calculate a modified first order difference MFD(\vec{A}(n)) of the vector sequence. A length operator is applied to the vector MFD(\vec{A}(n)) to obtain a scalar quantity ∥MFD(\vec{A}(n))∥ at each point n of the vector sequence. The boundary detection controller identifies a local maximum of the scalar quantity ∥MFD(\vec{A}(n))∥ as a boundary location if the local maximum of the scalar quantity ∥MFD(\vec{A}(n))∥ is greater than a predetermined threshold value.

The boundary detection controller of the present invention is also capable of analyzing luminance and chrominance portions of a color image signal to locate luminance edges and chrominance edges in the color image signal.

It is an object of the present invention to provide an apparatus and method to accurately detect luminance edges in a color image signal.

It is also an object of the present invention to provide an apparatus and method to accurately detect chrominance edges in a color image signal.

It is another object of the present invention to provide an apparatus and method that uses both luminance values and chrominance values of a color image signal to accurately detect edges in the color image signal.

The foregoing has outlined rather broadly the features and technical advantages of the present invention so that those skilled in the art may better understand the Detailed Description of the Invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is a block diagram of an exemplary digital color television set with an exemplary edge detection unit of the present invention for boundary detection in vector sequences and edge detection in color image signals;

FIG. 2 is a block diagram showing a more detailed view of the exemplary edge detection unit shown in FIG. 1;

FIG. 3 is a diagram showing how an accurate boundary may be located between two neighbor integers, n and n−1, using the apparatus and method of the present invention; and

FIG. 4 is a schematic diagram showing the geometry of the triangles shown in FIG. 3.

### DETAILED DESCRIPTION OF THE INVENTION

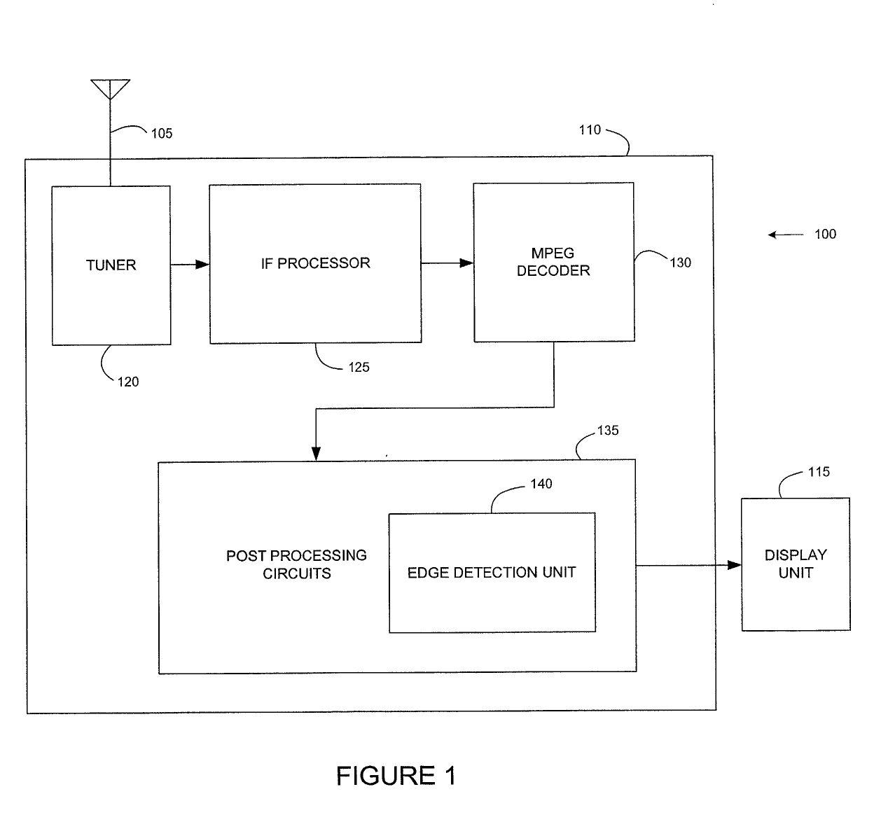

FIGS. 1 and 4, discussed below, and the various embodiments set forth in this patent document to describe the principles of the apparatus and method of the present invention are by way of illustration only and should not be construed in any way to limit the scope of the invention. The apparatus and method of the present invention will be described as an apparatus and method for accurately detecting edges in color image signals in a digital color television set. It is important to realize that the apparatus and method of the present invention is not limited to digital color television sets. Those skilled in the art will readily understand that the principles of the present invention may also be successfully applied in any type of color image system, including, without limitation, television receivers, set top boxes, storage devices, computer video display systems, and any type of electronic equipment that utilizes or processes color image signals. The term “color image system” is used to refer to these types of equipment. In the descriptions that follow, a digital television set is employed as an illustration of a color image system.

FIG. 1 is a block diagram of a digital color television set 100 that utilizes the apparatus and method of the present invention. Digital color television set 100 comprises television receiver 110 and display unit 115. Display unit 115 may be a cathode ray tube or a flat panel display or any type of equipment for displaying video. Television receiver 110 comprises antenna 105 for receiving television signals. Antenna 105 is coupled to tuner 120. Tuner 120 is coupled to intermediate frequency (“IF”) processor 125. IF processor 125 is coupled to MPEG decoder 130.

The apparatus and method of the present invention detects edges in color image signals within television receiver 110. The output of MPEG decoder 130 is coupled to post-processing circuits 135. Post processing circuits 135 comprise edge detection unit 140 of the present invention. Edge detection unit 140 may be located at an appropriate location within the post-processing circuits 135. The output of post-processing circuits 135 is input to display unit 115.

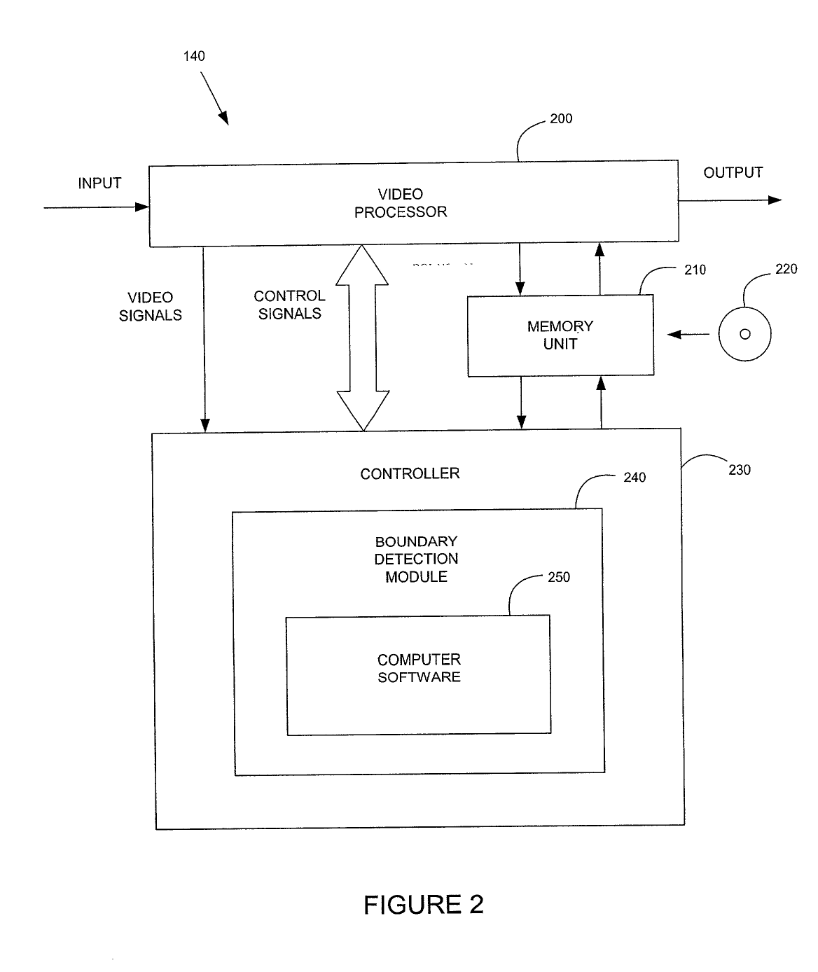

Edge detection unit 140 processes video signals that are received by post-processing circuits 135 from MPEG decoder 130. As shown in more detail in FIG. 2, edge detection unit 140 comprises video processor 200. Video processor 200 receives video signals and analyzes the content of the video signals. Video processor 200 may store video signal components in memory unit 210.

Memory unit 210 may comprise random access memory (RAM) or a combination of random access memory (RAM) and read only memory (ROM). Memory unit 210 may comprise a non-volatile random access memory (RAM), such as flash memory. Memory unit 210 may comprise a mass storage data device, such as a hard disk drive (not shown). Memory unit 210 may also comprise an attached peripheral drive or removable disk drive (whether embedded or attached) that reads read/write DVDs or re-writable CD-ROMs. As illustrated in FIG. 2, removable disk drives or this type are capable of receiving and reading re-writable CD-ROM disk 220.

Video processor 200 provides video signals to controller 230 of the present invention. Controller 230 is capable of receiving control signals from video processor 200. Controller 230 is also capable of sending control signals to video processor 200. Controller 230 is also coupled to video processor 200 through memory unit 210. Video processor 200 and controller 230 operate using conventional operating system software (not shown).

As will be more fully described, controller 230 is capable of detecting boundaries in vector sequences representing the video signals. Controller 230 is also capable of detecting edges in color image signals within said video signals. Controller 230 is also capable of storing within memory unit 210 (1) information concerning the location of the detected boundaries within the video signals, and (2) video images showing the location of the detected boundaries. Video processor 200, in response to a user request, is capable of accessing video signals showing the location of the detected boundaries and outputting the video signals to display unit 115 (shown in FIG. 1).

Controller 230 contains boundary detection module 240. Boundary detection module 240 contains computer software 250 that is capable of executing the steps of the method of the present invention. Controller 230 and computer software 250 together comprise a boundary detection controller that is capable of carrying out the present invention. Under the direction of instructions in computer software 250 stored within controller 230 (or stored within memory unit 210 ), controller 230 is capable of detecting boundaries in vector sequences and edges in color image signals in accordance with the method of the present invention. To understand the operation of controller 230 and computer software 250, one must understand how the method steps of the present invention are performed.

1. Boundary Detection Algorithm

Assume that \vec{A}(n) is a p dimensional vector sequence:

\vec{A}(n)=[a₁(n),a₂(n), . . . , aₚ(n)] (1)

where n is an integer and p is a natural number.

The first order difference of \vec{A}(n), which represents the change of \vec{A}(n), is normally defined as:

FD(\vec{A}(n))=\vec{A}(n)−\vec{A}(n−1). (2)

Because the frequency contents of \vec{A}(n) may be band limited, a modified first order difference for \vec{A}(n) may be defined as follows:

MFD(\vec{A}(n))=f(\vec{A}(n−q), . . . , \vec{A}(n−1), \vec{A}(n), \vec{A}(n+1), . . . , \vec{A}(n+q)) 93)

where q is a natural number. The function f(•) is a function of (\vec{A}(n−q), . . . , \vec{A}(n−1), \vec{A}(n), \vec{A}(n+1), . . . , \vec{A}(n+q)), which depends upon the frequency characteristic of \vec{A}(n). For example, MFD (\vec{A}(n)) may take the form of a simple filter such as [−1, −1, −1, +1, +1, +1].

Let ∥•∥ represent the length operator for a vector. Then the length operator operating on MFD(\vec{A}(n)) gives:

∥MFD(\vec{A}(n))∥=∥f(\vec{A}(n−q), . . . , \vec{A}(n−1), \vec{A}(n), \vec{A}(n+1), . . . , \vec{A}(n+q))∥. (4)

The expression ∥MFD(\vec{A}(n))∥ is a scalar value that represents the size of the change of sequence \vec{A}(n) at point n.

If \vec{A}(n) is in the Euclidean space, then

∥\vec{A}(n)∥=\sqrt{a₁²(n)+a₂²(n)+. . . +aₚ²(n)} (5)

A boundary is formed at a location where a signal has an abrupt change. If n is a boundary for \vec{A}(n), then ∥MFD(\vec{A}(n))∥ must be a local maximum. This means that:

∥MFD(\vec{A}(n))∥>Maximum {∥MFD(\vec{A}(n−1)∥, ∥MFD(\vec{A}(n+1)∥} (6)

The boundary detection for \vec{A}(n) becomes a detection of a local maximum for ∥MFD(\vec{A}(n)∥. The local maximum is very sensitive to noise. In order to be robust against noise, the size of the change must be larger than a threshold value THD. This means that:

∥MFD(\vec{A}(n))∥>THD (7)

If both Equation (6) and Equation (7) are true, then n is an edge point of \vec{A}(n). That is, if ∥MFD(\vec{A}(n))∥ is a local maximum and if ∥MFD(\vec{A}(n))∥ is greater than the threshold value THD, then n is an edge point of \vec{A}(n).

A boundary may be detected on an integer level by checking Equation (6) and Equation (7). Specifically, a boundary may be located between two neighbor integers, for example, n and n−1. To locate the boundary accurately, the difference of the length of the modified first order difference for \vec{A}(n) is needed. The difference of the length of the modified first order difference for \vec{A}(n) may be defined as:

DLMFD(\vec{A}(n))=∥MFD(\vec{A}(n+1))∥−∥MFD(\vec{A}(n−1))∥ (8)

If there is a boundary between two neighbor integers, n and n−1, then

DLMFD(\vec{A}(n))×DLMFD(\vec{A}(n−1))<0 (9)

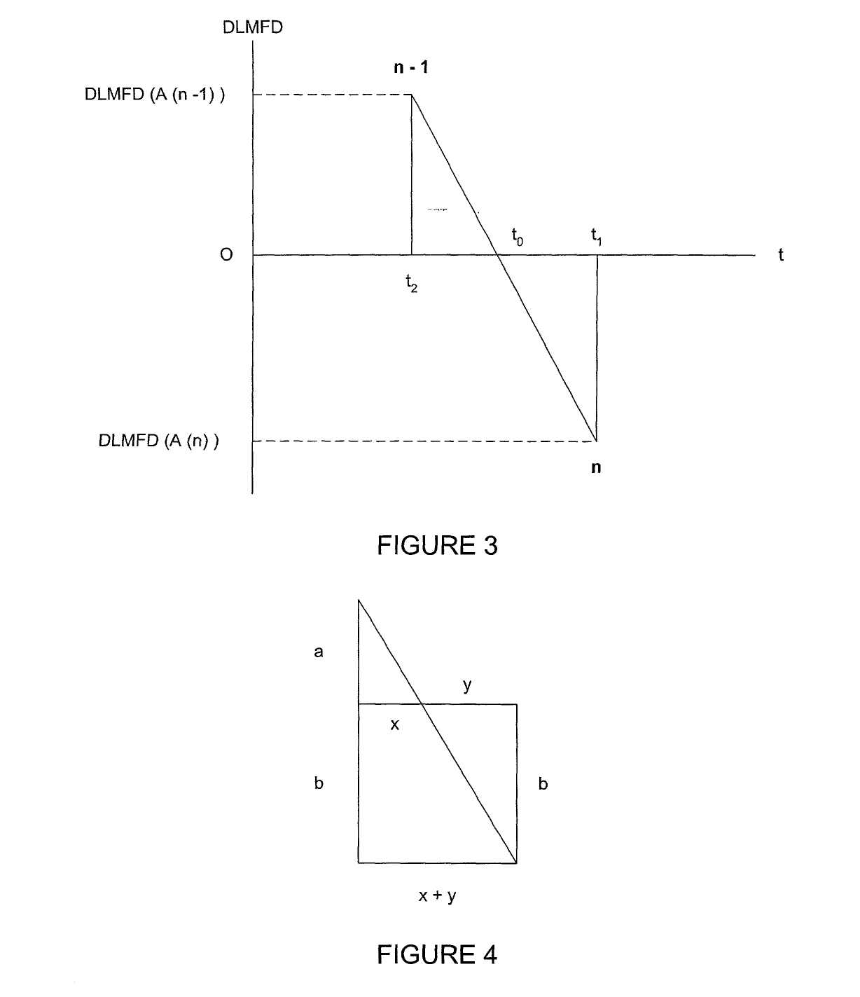

FIG. 3 is a diagram illustrating how an accurate boundary may be located between two neighbor integers, n and n−1, using the method of the present invention. Integer n is located at position “t₁” on the horizontal “t” axis. The letter “t” represents distance from the origin O. Integer n−1 is located at position “t₂” on the horizontal “t” axis. The vertical axis labeled “DLMFD” represents the values of the difference of the length of the modified first order difference for \vec{A}(n). As shown in FIG. 3, the value of DLMFD(A(n−1)) for integer n−1 is a positive value and the value of DLMFD(A(n)) for integer n is a negative value. The value t₀ on the “t” axis denotes the zero crossing of a straight line drawn from between the DLMFD values of the integers n and n−1. The value to represents an accurate value for the location of the boundary between integers n and n−1.

FIG. 4 shows a schematic diagram of the geometry of the triangles of FIG. 3. The letter “x” represents the distance along the “t” axis from the value “t₂” to the value “t₀”. The letter “y” represents the distance along the “t” axis from the value “t₀” to the value “t₁”. The letter “a” represents the distance along the DLMFD axis from the origin “O” to the value represented by DLMFD(A(n−1)). The letter “b” represents the distance along the DLMFD axis from the origin “O” to the value represented by DLMFD(A(n)).

From trigonometry it is seen that the ratio “x/a” is equal to the ratio “(x+y)/(a+b)”. This equivalence means that

$$\frac{x}{x + y} = \frac{a}{a + b} \qquad ( 10 )$$

Because x+y also represents the horizontal distance between the integers n and n−1, the value of x+y is equal to one.

x+y=n−(n−1)=1 (11)

This result gives

$$x = \frac{a}{a + b} \qquad ( 12 )$$

In terms of the value t₀, the value of x is

x=t₀−(n−1) (13)

Then t₀ is equal to

t₀=x+(n−1) (14)

Substituting Equation (12) into Equation (14) and substituting the DLMFD values of “a” and “b” gives

$${t}_{0} = \frac{\vert DLMFD ( \vec{A} ( n - 1 ) ) \vert}{\vert DLMFD ( \vec{A} ( n - 1 ) ) \vert + \vert DLMFD ( \vec{A} ( n ) ) \vert} + n - 1 \qquad ( 15 )$$

Equation (15) gives an accurate value t₀ for the location of is the boundary between integers n and n−1. This example shows how the method of the present invention may be used to accurately determine boundaries in vector sequences.

2. Edge Detection for Color Image Signals

The use of color information in the process of image segmentation has been the subject of much research. Most prior art approaches to the problem, however, pre-cluster the chrominance color space into a number of regions, and then classify pixels into the pre-clustered regions. A significant disadvantage of this type of approach is that pixels that are located on the boundary between two pre-clustered regions are forced into the two different pre-clustered regions. Forcing boundary pixels into the two different pre-clustered regions causes over segmentation. Additional techniques then have to be used to compensate. Existing prior art color segmentation approaches are therefore not able to give accurate edge information.

Many types of edge detection techniques based on luminance information (i.e., Y information) have been relatively well developed. Luminance information has only one dimension. This is; feature makes it relatively easy to accurately detect luminance edge information.

A color space may be represented by a number of different coordinate systems. For example, well known color space coordinates systems include the (Y, U, V) system, the (R, G, B) system, the (L, a, b) system, the (X, Y, Z) system, and the (I, H, S) system. Of these systems, the (I, H, S) system is the one most closely related to human perception.

An input video signal is normally represented in the (R, G, B) system or in the (Y, U, V) system. The mathematical process of multiplication and the mathematical process of division are required to convert between the (R, G, B) system and the (Y, U, V) system. The mathematical process of division is required to convert from the (Y, U, V) system to the (I, H, S) system. Because implementations of the mathematical process of division are very sensitive to noise, the (Y, U, V) coordinate system is a suitable candidate coordinate system for applying the boundary detection algorithm of the present invention.

The boundary detection algorithm previously described in Section 1 has two key components. The first key component is the length operator ∥•∥. For the (Y,U,V) coordinate system, the Euclidean distance (see Equation (5) above) may be used as the length operator. The second key component is the design of the function f(•). The function f(•) depends on the frequency characteristic of \vec{A}(n). Therefore, to correctly select an appropriate function f(•), one must take into account the signal bandwidth of each of the signal components Y, U, and V.

A video sequence contains a huge number of pixels. Each pixel is represented by a three dimensional vector in a color space. For example, a pixel may be represented by a three dimensional vector in which a first component is a Y value, a second component is a U value, and a third component is a V value. The color vector of a pixel establishes a value of color for the pixel.

In addition to having a color value, each pixel has a spatial and temporal location. Specifically, each pixel in a video sequence has an “x” value locating the pixel in a left-right direction, a “y” value locating the pixel in an up-down direction, and a “t” value locating the pixel in time. That is, the x, y, and t values locate the pixel within an x-y plane at a particular time t.

The method of edge detection of the present invention is used to detect edges within the spatial x-y domain. More specifically, the locations of the edges are detected from the color components Y(x, y), U(x, y), and V(x, y). The value of x varies from zero up to a value equal to the number of pixels per line minus one. The value of y varies from zero up to a value equal to the number of lines in the image minus one.

There are therefore two index variables, x and y, in each color component Y(x, y), U(x, y), and V(x, y). The boundary detection algorithm previously described in Section 1 only works on one index variable at a time. Therefore, the boundary detection algorithm is first applied to find the location of the boundary in the x direction. Then the boundary detection algorithm is applied again to find the location of the boundary in the y direction. Then the detected horizontal edges are combined with the detected vertical edges to construct an edge map. For example, a diagonal edge within an x-y plane may be constructed by combining horizontal edge information and vertical edge information obtained separately by applying the boundary detection algorithm once in each direction.

The method of edge detection of the present invention may be applied to television images. For analog television broadcasts, the bandwidth of the chrominance signal U and the bandwidth of the chrominance signal V is one fourth (¼) of the bandwidth of the luminance signal Y. For digital television broadcasts, there are several different sampling formats (e.g., YUV 444, YUV 422, YUV 411, YUV 420). Therefore, the bandwidth for the luminance signal Y is very likely to be different from the bandwidth of the chrominance signals, U and V.

Different bandwidths for elements of a vector space such as the vector space (Y, U, V) cause different eigenvalue spreading. Therefore, in order to obtain an optimal solution to the problem of image edge detection, it is necessary to distinguish two situations.

First, consider the case where the signals Y, U, and V each have an equal normalized bandwidth. It is then possible to directly detect an edge in the (Y, U, V) vector space of a color image signal by using the boundary detection algorithm previously described in Section 1. Assume that the normalized bandwidth for the signals Y, U, and V is B_{YUV}. The expression L_{YUV}(n) represents a low pass filter with a cut-off frequency of B_{YUV}. Then a function f_{YUV}(n) may be obtained from:

f_{YUV}(n)=L_{YUV}(n)\mathring{x}[−101] (16)

where the symbol \mathring{x} represents the convolution operation. The matrix [−1, 0, 1] represents the first order difference of vector space (Y, U, V).

The function f_{YUV} (n) represents a modified first order difference vector for vector space (Y, U, V). For vector space (Y, U, V) the Euclidean length operator (refer to Equation 5) must be used. The modified first order difference vector f_{YUV}(n) is operated on with the Euclidean length operator to obtain a scalar value ∥f_{YUV}(n)∥ that represents a value of a change in said vector space (Y, U, V) at point n.

Then a local maximum of the scalar value ∥f_{YUV}(n)∥ is detected and a determination is made whether the local maximum of the scalar value ∥f_{YUV}(n)∥ is larger than a predetermined threshold value THD. Point n is selected as an edge point of vector space (Y, U, V) when the local maximum of the scalar value ∥f_{YUV}n)∥ is larger than the predetermined threshold value THD.

An edge between two neighbor integers, n and n−1, is then determined by locating a zero crossing of a difference of a length of said modified first order difference vector for vector space (Y, U, V), denoted DLf_{YUV}(n), where the difference of a length of said modified first order difference vector is calculated using the expression:

DLf_{YUV}(n)=∥f_{YUV}(n+1)∥−∥f_{YUV}(n−1)∥. (17)

An accurate location for the edge between integers n and n−1 is then obtained from the expression:

$${t}_{0} = \frac{\vert {DLf}_{YUV} ( n - 1 ) \vert}{\vert {DLf}_{YUV} ( n - 1 ) \vert + \vert {DLf}_{YUV} ( n ) \vert} + n - 1 \qquad ( 18 )$$

This example shows how the method of the present invention may be used to accurately determine an edge in a vector space (Y, U, V) of a color image signal.

Second, consider the case where the chrominance signals U and V have a smaller bandwidth than the luminance signal Y. Because the luminance signal Y is more dominant, the edge detection method need to be implemented in three steps.

Step One. Determine the luminance edge using Y information to perform the edge detection method described above. Assume that the normalized bandwidth for the Y signal is B_{Y}. The expression L_{Y}(n) represents a low pass filter with a cut-off frequency of B_{Y}. Then the function f_{Y}(n) may be obtained from:

f_{Y}(n)=L_{Y}(n)\mathring{x}[−101] (19)

where the symbol \mathring{x} represents the convolution operation. The matrix [−1,0,1] represents the first order difference of the vector space (Y, U, V).

Step Two. Determine the chrominance edge using U and V information to perform the edge detection method described above. Assume that the normalized bandwidth for the U signal and the V signal is B_{UV}. The expression L_{UV}(n) represents a low pass filter with a cut-off frequency of B_{UV}. Then the function f_{UV}(n) may be obtained from:

f_{UV}(n)=L_{UV}(n)\mathring{}[−101] (20)

where the symbol \mathring{x} represents the convolution operation. The matrix [−1, 0, 1] represents the first order difference of vector space (Y, U, V).

Step Three. Combine the luminance edge information and the chrominance edge information. If only a luminance edge is detected, then the luminance edge is selected to represent the edge boundary. If only a chrominance edge is detected, then the chrominance edge is selected to represent the edge boundary. Depending on the image content, some locations may have both a luminance edge and a chrominance edge. If the luminance edge and the chrominance edge are at the same location, then that location is selected to represent the edge boundary.

Due to different delays in the transmission path, the luminance edge and the chrominance edge may not be at exactly the same location. If the luminance edge is very close to the chrominance edge (e.g., within two to four pixels) the luminance edge is selected to represent the edge boundary.

Using both luminance information and chrominance information to locate edges in a color image enables more edges to be located than can be located using only luminance information.

The present invention has been described as an apparatus and method for use within a digital color television receiver. The apparatus and method of the present invention can be used within a number of different types of video equipment. For example, the present invention can be used within an analog television receiver, or within a set top box for use with a television receiver, or within a computer display unit, or within an Internet appliance that is capable of receiving video signals from the Internet.

Although the present invention has been described in detail, those skilled in the art should understand that they can make various changes, substitutions and alterations herein without departing from the spirit and scope of the invention in its broadest form.

What is claimed is:

1. An apparatus for detecting a boundary in a vector sequence representing a signal, said apparatus comprising:
a boundary detection controller capable of detecting a boundary in a vector sequence \vec{A}(n) having an arbitrary dimension by selecting a function to represent a modified first order difference vector of said vector sequence \vec{A}(n), denoted MFD(\vec{A}(n)), wherein said function is dependent upon a frequency characteristic of said vector sequence A(n);
wherein said boundary detection controller is capable of operating upon said modified first order difference vector MFD(\vec{A}(n)) with a length operator to obtain a scalar value ∥MFD(\vec{A}(n))∥ that represents a value of a change in said vector sequence \vec{A}(n) at point n and detecting a local maximum of said scalar value ∥MFD(\vec{A}(n))∥; and
wherein said boundary detection controller is capable of determining whether said local maximum of said scalar value ∥MFD(\vec{A}(n))∥ is larger than a predetermined threshold value.

2. An apparatus for detecting a boundary in a vector sequence representing a signal as set forth in claim 1 wherein said boundary detection controller is capable of selecting point n as an edge point of \vec{A}(n) when said local maximum of said scalar value ∥MFD(\vec{A}(n))∥ is larger than said predetermined threshold value.

3. An apparatus for detecting a boundary in a vector sequence representing a signal as set forth in claim 1 wherein said vector sequence \vec{A}(n) is in Euclidean space and said length operator has the form:
∥\vec{A}(n)∥=√\vec{a₁²(n)+a₂²(n)+ . . . +aₚ²(n)}.

4. An apparatus for detecting a boundary in a vector sequence as claimed in claim 2 wherein said boundary detection controller is capable of locating a boundary between two neighbor integers, n and n−1, by locating a zero crossing of a difference of a length of said modified first order difference vector for \vec{A}(n), denoted DLMFD(\vec{A}(n)), where said difference of a length of said modified first order difference vector is calculated by subtracting an absolute value of said scalar value ∥MFD(\vec{A}(n−1))∥ from an absolute value of said scalar value ∥MFD(\vec{A}(n+1))∥.

5. An apparatus for detecting a boundary in a vector sequence as claimed in claim 4 wherein said boundary detection controller is capable of locating said zero crossing of a difference of a length of said modified first order difference vector for \vec{A}(n) by calculating said location of said boundary between said two neighbor integers, n and n−1, using the expression:
$${t}_{0} = \frac{\vert DLMFD ( \vec{A} ( n - 1 ) ) \vert}{\vert DLMFD ( \vec{A} ( n - 1 ) ) \vert + \vert DLMFD ( \vec{A} ( n ) ) \vert} + n - 1$$
where t₀ represents a location of said boundary, and where n represents a value of said integer n, and where |DLMFD\vec{A}((n))| represents an absolute value of a difference of a length of a modified first order difference of said vector sequence \vec{A}(n) at a location of said integer n, and where |DLMFD\vec{A}((n−1)) | represents an absolute value of a difference of a length of a modified first order difference of said vector sequence \vec{A}(n) at a location of said integer n−1.

6. An apparatus for detecting an edge in a vector space (Y, U, V) of a color image signal as set forth in claim 1, where Y represents a luminance signal, and where U and V represent chrominance signals, and where said Y, U, and V signals have an equal normalized bandwidth, said apparatus comprising:
a boundary detection controller capable of selecting a function to represent a modified first order difference vector of said vector space (Y, U, V), denoted f_{YUV}(n), wherein said function f_{YUV}(n) is calculated by convolving a low pass filter L_{YUV}(n) with a matrix [−1, 0, 1] representing a first order difference of said vector space (Y, U, V), wherein said low pass filter L_{YUV}(n) has a cut-off frequency equal to said normalized bandwidth for signals Y, U, and V;
wherein said boundary detection controller is capable of operating upon said modified first order difference vector f_{YUV}(n) with a Euclidean length operator to obtain a scalar value ∥f_{YUV}(n)∥ that represents a value of a change in said vector space (Y, U, V) at point n and detecting a local maximum of said scalar value f_{YUV}(n)∥; and
wherein said boundary detection controller is capable of determining whether said local maximum of said scalar value ∥f_{YUV}(n)∥ Is larger than a predetermined threshold value.

7. An apparatus for detecting an edge in a vector space (Y, U, V) as claimed in claim 6, wherein said boundary detection controller is capable of selecting point n as an edge point of vector space (Y, U, V) when said local maximum of said scalar value ∥f_{YUV}(n)∥ is larger than said predetermined threshold value.

8. An apparatus for detecting an edge in a vector space (Y, U, V) as claimed in claim 7, wherein said boundary detection controller is capable of locating a boundary between two neighbor integers, n and n−1, by locating a zero crossing of a difference of a length of said modified first order difference vector for vector space (Y, U, V), denoted DLf_{YUV}(n), where said difference of a length of said modified first order difference vector is calculated by subtracting an absolute value of said scalar value ∥f_{YUV}(n−1)∥ from an absolute value of said scalar value ∥f_{YUV}(n+1)∥.

9. An apparatus for detecting an edge in a vector space (Y, U, V) as claimed in claim 8, wherein said boundary detection controller is capable of locating said zero crossing of a difference of a length of said modified first order difference vector for vector space (Y, U, V) by calculating said location of said boundary between said two neighbor integers, n and n−1, using the expression: DLf_{YUV}(n)
$${t}_{0} = \frac{\vert {DLf}_{YUV} ( n - 1 ) \vert}{\vert {DLf}_{YUV} ( n - 1 ) \vert + \vert {DLf}_{YUV} ( n ) \vert} + n - 1$$
where t₀ represents a location of said boundary, and where n represents a value of said integer n, and where |DLf_{YUV}(n−1)| represents an absolute value of a difference of a length of a modified first order difference of said vector space (Y, U, V) at a location of said integer n, and where |DLf_{YUV}(n−1)| represents an absolute value of a difference of a length of a modified first order difference of said vector space (Y, U, V) at a location of said integer n−1.

10. An apparatus for detecting an edge in a vector space (Y, U, V) of a color image signal as set forth in claim 6, where Y represents a luminance signal, and where U and V represent chrominance signals, and where said U and V signals have a smaller normalized bandwidth than a normalized bandwidth of said Y signal, said apparatus comprising:
a boundary detection controller capable of locating a luminance edge in said vector space (Y, U, V) of said color image signal and capable of locating a chrominance edge in said vector space (Y, U, V) of said color image signal;
wherein said boundary detection controller is capable of combining luminance edge information and chrominance edge information to determine said edge in said vector space (Y, U, V) of said color image signal.

11. An apparatus for detecting an edge in a vector space (Y, U, V) of a color image signal as claimed in claim 10, wherein said boundary detection controller is capable of selecting said luminance edge as said edge in said vector space (Y, U, V) of said color image signal when said chrominance edge is located within two to four pixels of said luminance edge.

12. A method for detecting a boundary in a vector sequence \vec{A}(n) having an arbitrary dimension, said method comprising the steps of:
selecting a function to represent a modified first order difference vector of said vector sequence \vec{A}(n), denoted MFD(\vec{A}(n)), wherein said function is dependent upon a frequency characteristic of said vector sequence \vec{A}(n);
operating upon said modified first order difference vector MFD(\vec{A}(n)) with a length operator to obtain a scalar value ∥MFD(\vec{A}(n))∥ that represents a value of a change in said vector sequence \vec{A}(n) at point n;
detecting a local maximum of said scalar value ∥MFD(\vec{A}(n))∥; and
determining whether said local maximum of said scalar value ∥MFD(\vec{A}(n))∥ is larger than a predetermined threshold value.

13. A method for detecting a boundary in a vector sequence \vec{A}(n) as claimed in claim 12, said method further comprising the step of:
selecting point n as an edge point of \vec{A}(n) when said local maximum of said scalar value ∥MFD(\vec{A}(n))∥ is larger than said predetermined threshold value.

14. A method for detecting a boundary in a vector sequence \vec{A}(n) as claimed in claim 12, wherein said vector sequence \vec{A}(n) is in Euclidean space and said length operator has the form:
∥\vec{A}(n)∥=√rad a₁²(n)+a₂²(n)+ . . . +aₚ²(n).

15. A method for detecting a boundary in a vector sequence \vec{A}(n) as claimed in claim 13, said method further comprising the step of:
locating a boundary between two neighbor integers, n and n−1, by locating a zero crossing of a difference of a length of said modified first order difference vector for \vec{A}(n), denoted DLMFD(\vec{A}(n)), where said difference of a length of said modified first order difference vector is calculated by subtracting an absolute value of said scalar value ∥MFD(\vec{A}(n−1)) ∥ from an absolute value of said scalar value ∥MFD(\vec{A}(n+1))∥.

16. A method for detecting a boundary in a vector sequence \vec{A}(n) as claimed in claim 15, wherein said step of locating a zero crossing of a difference of a length of said modified first order difference vector for \vec{A}(n) further comprises the step of:
calculating said location of said boundary between said two neighbor integers, n and n−1, using the expression:
$${t}_{0} = \frac{\vert DLMFD ( \vec{A} ( n - 1 ) ) \vert}{\vert DLMFD ( \vec{A} ( n - 1 ) ) \vert + \vert DLMFD ( \vec{A} ( n ) ) \vert} + n - 1$$
where t₀ represents a location of said boundary, and where n represents a value of said integer n, and where |DLMFD\vec{A}((n))| represents an absolute value of a difference of a length of a modified first order difference of said vector sequence \vec{A}(n) at a location of said integer n, and where |DLMFD\vec{A}((n−1))| represents an absolute value of a difference of a length of a modified first order difference of said vector sequence \vec{A}(n) at a location of said integer n−1.

17. A method for detecting an edge in a vector space (Y, U, V) of a color image signal as set forth in claim 12, where Y represents a luminance signal, and where U and V represent chrominance signals, and where said Y, U, and V signals have an equal normalized bandwidth, said method comprising the steps of:
selecting a function to represent a modified first order difference vector of said vector space (Y, U, V), denoted f_{YUV}(n), wherein said function f_{YUV}(n) is calculated by convolving a low pass filter L_{YUV}(n) with a matrix [−1, 0, 1] representing a first order difference of said vector space (Y, U, V), wherein said low pass filter L_{YUV}(n) has a cut-off frequency equal to said normalized bandwidth for signals Y, U, and V;
operating upon said modified first order difference vector f_{YUV}(n) with a Euclidean length operator to obtain a scalar value ∥f_{YUV}(n)∥ that represents a value of a change in said vector space (Y, U, V) at point n;
detecting a local maximum of said scalar value ∥f_{YUV}(n)∥; and
determining whether said local maximum of said scalar value ∥f_{YUV}(n)∥ is larger than a predetermined threshold value.

18. A method for detecting an edge in a vector space (Y, U, V) as claimed in claim 17, said method further comprising the step of:
selecting point n as an edge point of vector space (Y, U, V) when said local maximum of said scalar value ∥f_{YUV}(n)∥ is larger than said predetermined threshold value.

19. A method for detecting an edge in a vector space (Y, U, V) as claimed in claim 18, said method further comprising the step of:
locating a boundary between two neighbor integers, n and n−1, by locating a zero crossing of a difference of a length of said modified first order difference vector for vector space (Y, U, V), denoted DLf_{YUV}(n), where said difference of a length of said modified first order difference vector is calculated by subtracting an absolute value of said scalar value ∥f_{YUV}(n−1)∥ from an absolute value of said scalar value ∥f_{YUV}(n+1)∥.

20. A method for detecting an edge in a vector space (Y, U, V) as claimed in claim 19, wherein said step of locating a zero crossing of a difference of a length of said modified first order difference vector for vector space (Y, U, V) further comprises the step of:
calculating said location of said boundary between said two neighbor integers, n and n−1, using the expression: DLf_{YUV}(n)
$${t}_{0} = \frac{\vert {DLf}_{YUV} ( n - 1 ) \vert}{\vert {DLf}_{YUV} ( n - 1 ) \vert + \vert {DLf}_{YUV} ( n ) \vert} + n - 1$$
where t₀ represents a location of said boundary, and where n represents a value of said integer n, and where |DLf_{YUV}(n−1)| represents an absolute value of a difference of a length of a modified first order difference of said vector space (Y, U, V) at a location of said integer n, and where |DLf_{YUV}(n−1)| represents an absolute value of a difference of a length of a modified first order difference of said vector space (Y, U, V) at a location of said integer n−1.

21. A method for detecting an edge in a vector space (Y, U, V) of a color image signal as set forth in claim 17, where Y represents a luminance signal, and where U and V represent chrominance signals, and where said U and V signals have a smaller normalized bandwidth than a normalized bandwidth of said Y signal, said method comprising the steps of:
locating a luminance edge in said vector space (Y, U, V) of said color image signal;
locating a chrominance edge in said vector space (Y, U, V) of said color image signal; and
combining luminance edge information and chrominance edge information to determine said edge in said vector space (Y, U, V) of said color image signal.

22. A method for detecting an edge in a vector space (Y, U, V) of a color image signal as claimed in claim 21, further comprising the step of:
selecting said luminance edge as said edge in said vector space (Y, U, V) of said color image signal when said chrominance edge is located within two to four pixels of said luminance edge.

23. A color image system comprising an apparatus for detecting a boundary in a vector sequence representing a signal, said apparatus comprising:
a boundary detection controller capable of detecting a boundary in a vector sequence \vec{A}(n) having an arbitrary dimension by selecting a function to represent a modified first order difference vector of said vector sequence \vec{A}(n), denoted MFD(\vec{A}(n)), wherein said function is dependent upon a frequency characteristic of said vector sequence \vec{A}(n);
wherein said boundary detection controller is capable of operating upon said modified first order difference vector MFD(\vec{A}(n)) with a length operator to obtain a scalar value ∥MFD(\vec{A}(n))∥ that represents a value of a change in said vector sequence \vec{A}(n) at point n and detecting a local maximum of said scalar value ∥MFD(\vec{A}(n))∥; and
wherein said boundary detection controller is capable of determining whether said local maximum of said scalar value ∥MFD(\vec{A}(n))∥ is larger than a predetermined threshold value.

24. A color image system comprising an apparatus for detecting a boundary in a vector sequence representing a signal as set forth in claim 23 wherein said boundary detection controller is capable of selecting point n as an edge point of \vec{A}(n) when said local maximum of said scalar value ∥MFD(\vec{A}(n))∥ is larger than said predetermined threshold value.

25. A color image system comprising an apparatus for detecting a boundary in a vector sequence representing a signal as set forth in claim 23 wherein said vector sequence \vec{A}(n) is in Euclidean space and said length operator has the form:
∥\vec{A}(n)∥=\sqrt{a₁²(n)+a₂²(n)+ . . . +aₚ²(n)}.

26. A color image system comprising an apparatus for detecting a boundary in a vector sequence as claimed in claim 24 wherein said boundary detection controller is capable of locating a boundary between two neighbor integers, n and n−1, by locating a zero crossing of a difference of a length of said modified first order difference vector for \vec{A}(n), denoted DLMFD(\vec{A}(n)) , where said difference of a length of said modified first order difference vector is calculated by subtracting an absolute value of said scalar value ∥MFD(\vec{A}(n−1))∥ from an absolute value of said scalar value ∥MFD(\vec{A}(n+1))∥.

27. A color image system comprising an apparatus for detecting a boundary in a vector sequence as claimed in claim 26 wherein said boundary detection controller is capable of locating said zero crossing of a difference of a length of said modified first order difference vector for \vec{A}(n) by calculating said location of said boundary between said two neighbor integers, n and n−1, using the expression:
$${t}_{0} = \frac{\vert DLMFD ( \vec{A} ( n - 1 ) ) \vert}{\vert DLMFD ( \vec{A} ( n - 1 ) ) \vert + \vert DLMFD ( \vec{A} ( n ) ) \vert} + n - 1$$
where t₀ represents a location of said boundary, and where n represents a value of said integer n, and where |DLMFD\vec{A}((n))| represents an absolute value of a difference of a length of a modified first order difference of said vector sequence \vec{A}(n) at a location of said integer n, and where |DLMFD\vec{A}((n−1))| represents an absolute value of a difference of a length of a modified first order difference of said vector sequence \vec{A}(n) at a location of said integer n−1.

28. A color image system comprising an apparatus for detecting an edge in a vector space (Y, U, V) of a color image signal as set forth in claim 23, where Y represents a luminance signal, and where U and V represent chrominance signals, and where said Y, U, and V signals have an equal normalized bandwidth, said apparatus comprising:
a boundary detection controller capable of selecting a function to represent a modified first order difference vector of said vector space (Y, U, V), denoted f_{YUV}(n), wherein said function f_{YUV}(n) is calculated by convolving a low pass filter L_{YUV}(n) with a matrix [−1, 0, 1] representing a first order difference of said vector space (Y, U, V), wherein said low pass filter L_{YUV}(n) has a cut-off frequency equal to said normalized bandwidth for signals Y, U, and V;
wherein said boundary detection controller is capable of operating upon said modified first order difference vector f_{YUV}(n) with a Euclidean length operator to obtain a scalar value ∥f_{YUV}(n) that represents a value of a change in said vector space (Y, U, V) at point n and detecting a local maximum of said scalar value ∥f_{YUV}(n)∥; and
wherein said boundary detection controller is capable of determining whether said local maximum of said scalar value ∥f_{YUV}(n)∥ is larger than a predetermined threshold value.

29. A color image system comprising an apparatus for detecting an edge in a vector space (Y, U, V) as claimed in claim 28, wherein said boundary detection controller is capable of selecting point n as an edge point of vector space (Y, U, V) when said local maximum of said scalar value ∥f_{YUV}(n)∥ is larger than said predetermined threshold value.

30. A color image system comprising an apparatus for detecting an edge in a vector space (Y, U, V) as claimed in claim 29, wherein said boundary detection controller is capable of locating a boundary between two neighbor integers, n and n−1, by locating a zero crossing of a difference of a length of said modified first order difference vector for vector space (Y, U, V), denoted DLf_{YUV}(n), where said difference of a length of said modified first order difference vector is calculated by subtracting an absolute value of said scalar value ∥f_{YUV}(n−1)∥ from an absolute value of said scalar value ∥f_{YUV}(n+1)∥.

31. A color image system comprising an apparatus for detecting an edge in a vector space (Y, U, V) as claimed in claim 30, wherein said boundary detection controller is capable of locating said zero crossing of a difference of a length of said modified first order difference vector for vector space (Y, U, V) by calculating said location of said boundary between said two neighbor integers, n and n−1, using the expression: DLf_{YUV}(n)
$${t}_{0} = \frac{\vert {DLf}_{YUV} ( n - 1 ) \vert}{\vert {DLf}_{YUV} ( n - 1 ) \vert + \vert {DLf}_{YUV} ( n ) \vert} + n - 1$$
where t₀ represents a location of said boundary, and where n represents a value of said integer n, and where |DLf_{YUV}(n−1)| represents an absolute value of a difference of a length of a modified first order difference of said vector space (Y, U, V) at a location of said integer n, and where |DLf_{YUV}(n−1)| represents an absolute value of a difference of a length of a modified first order difference of said vector space (Y, U, V) at a location of said integer n−1.

32. A color image system comprising an apparatus for detecting an edge in a vector space (Y, U, V) of a color image signal as set forth in claim 28, where Y represents a luminance signal, and where U and V represent chrominance signals, and where said U and V signals have a smaller normalized bandwidth than a normalized bandwidth of said Y signal, said apparatus comprising:
a boundary detection controller capable of locating a luminance edge in said vector space (Y, U, V) of said color image signal and capable of locating a chrominance edge in said vector space (Y, U, V) of said color image signal;
wherein said boundary detection controller is capable of combining luminance edge information and chrominance edge information to determine said edge in said vector space (Y, U, V) of said color image signal.

33. A color image system comprising an apparatus for detecting an edge in a vector space (Y, U, V) of a color image signal as claimed in claim 32, wherein said boundary detection controller is capable of selecting said luminance edge as said edge in said vector space (Y, U, V) of said color image signal when said chrominance edge is located within two to four pixels of said luminance edge.

34. Computer-executable instructions stored on a computer-readable storage medium for detecting a boundary in a vector sequence \vec{A}(n) having an arbitrary dimension, the computer-executable instructions comprising the steps of:
selecting a function to represent a modified first order difference vector of said vector sequence \vec{A}(n), denoted MFD(\vec{A}(n)), wherein said function is dependent upon a frequency characteristic of said vector sequence \vec{A}(n);
operating upon said modified first order difference vector MFD(\vec{A}(n)) with a length operator to obtain a scalar value ∥MFD(\vec{A}(n))∥ that represents a value of a change in said vector sequence \vec{A}(n) at point n;
detecting a local maximum of said scalar value ∥MFD(\vec{A}(n))∥; and
determining whether said local maximum of said scalar value ∥MFD(\vec{A}(n))∥ is larger than a predetermined threshold value.

35. The computer-executable instructions stored on a computer-readable storage medium as claimed in claim 34 further comprising the step of:
selecting point n as an edge point of \vec{A}(n) when said local maximum of said scalar value ∥MFD(\vec{A}(n))∥ is larger than said predetermined threshold value.

36. The computer-executable instructions stored on a computer-readable storage medium as claimed in claim 34, wherein said vector sequence \vec{A}(n) is in Euclidean space and said length operator has the form:
∥\vec{A}(n)∥={square root over (a₁²(n)+a₂²9n)+ . . . +aₚ²(n))}.

37. The computer-executable instructions stored on a computer-readable storage medium as claimed in claim 35 further comprising the step of:
locating a boundary between two neighbor integers, n and n−1, by locating a zero crossing of a difference of a length of said modified first order difference vector for \vec{A}(n), denoted DLMFD(\vec{A}(n)), where said difference of a length of said modified first order difference vector is calculated by subtracting an absolute value of said scalar value ∥MFD(\vec{A}(n−1))∥ from an absolute value of said scalar value ∥MFD(\vec{A}(n+1))∥.

38. The computer-executable instructions stored on a computer-readable storage medium as claimed in claim 37, wherein said step of locating a zero crossing of a difference of a length of said modified first order difference vector for \vec{A}(n) further comprises the step of:
calculating said location of said boundary between said two neighbor integers, n and n−1, using the expression:
$${t}_{0} = \frac{\vert DLMFD ( {A}^{->} ( n - 1 ) ) \vert}{\vert DLMFD ( {A}^{->} ( n - 1 ) ) \vert + \vert DLMFD ( {A}^{->} ( n ) ) \vert} + n - 1$$
where t₀ represents a location of said boundary, and where n represents a value of said integer n, and where |DLMFD\vec{A}((n))| represents an absolute value of a difference of a length of a modified first order difference of said vector sequence \vec{A}(n) at a location of said integer n, and where |DLMFD\vec{A}((n−1))| represents an absolute value of a difference of a length of a modified first order difference of said vector sequence \vec{A}(n) at a location of said integer n−1.

39. The computer-executable instructions stored on a computer-readable storage medium for detecting an edge in a vector space (Y, U, V) of a color image signal as set forth in claim 34, where Y represents a luminance signal, and where U and V represent chrominance signals, and where said Y, U, and V signals have an equal normalized bandwidth, the computer-executable instructions comprising the steps of:
selecting a function to represent a modified first order difference vector of said vector space (Y, U, V), denoted f_{YUV}(n), wherein said function f_{YUV}(n) is calculated by convolving a low pass filter L_{YUV}(n) with a matrix [−1, 0, 1] representing a first order difference of said vector space (Y, U, V), wherein said low pass filter L_{YUV}(n) has a cut-off frequency equal to said normalized bandwidth for signals Y, U, and V;
operating upon said modified first order difference vector f_{YUV}(n) with a Euclidean length operator to obtain a scalar value ∥f_{YUV}(n)∥ that represents a value of a change in said vector space (Y, U, V) at point n;
detecting a local maximum of said scalar value ∥f_{YUV}(n)∥; and
determining whether said local maximum of said scalar value ∥f_{YUV}(n)∥ is larger than a predetermined threshold value.

40. The computer-executable instructions stored on a computer-readable storage medium as claimed in claim 39 further comprising the step of:
selecting point n as an edge point of vector space (Y, U, V) when said local maximum of said scalar value ∥f_{YUV}(n)∥ is larger than said predetermined threshold value.

41. The computer-executable instructions stored on a computer-readable storage medium as claimed in claim 40 further comprising the step of:
locating a boundary between two neighbor integers, n and n−1, by locating a zero crossing of a difference of a length of said modified first order difference vector for vector space (Y, U, V), denoted DLf_{YUV}(n), where said difference of a length of said modified first order difference vector is calculated by subtracting an absolute value of said scalar value ∥f_{YUV}(n−1)∥ from an absolute value of said scalar value ∥f_{YUV}(n+1)∥.

42. The computer-executable instructions stored on a computer-readable storage medium as claimed in claim 41 wherein said step of locating a zero crossing of a difference of a length of said modified first order difference vector for vector space (Y. U, V) further comprises the step of:
calculating said location of said boundary between said two neighbor integers, n and n−1, using the expression: DLf_{YUV}(n)
$${t}_{0} = \frac{\vert DL {f}_{YUV} ( n - 1 ) \vert}{\vert DL {f}_{YUV} ( n - 1 ) \vert + \vert DL {f}_{YUV} ( n ) \vert} + n - 1$$
where t₀ represents a location of said boundary, and where n represents a value of said integer n, and where |DLf_{YUV}(n−1)| represents an absolute value of a difference of a length of a modified first order difference of said vector space (Y, U, V) at a location of said integer n, and where |DLf_{YUV}(n−1)| represents an absolute value of a difference of a length of a modified first order difference of said vector space (Y, U, V) at a location of said integer n−1.

43. The computer-executable instructions stored on a computer-readable storage medium for detecting an edge in a vector space (Y, U, V) of a color image signal as set forth in claim 39, where Y represents a luminance signal, and where U and V represent chrominance signals, and where said U and V signals have a smaller normalized bandwidth than a normalized bandwidth of said Y signal, said computer-executable instructions comprising the steps of:
locating a luminance edge in said vector space (Y, U, V) of said color image signal;
locating a chrominance edge in said vector space (Y, U, V) of said color image signal; and
combining luminance edge information and chrominance edge information to determine said edge in said vector space (Y, U, V) of said color image signal.

44. The computer-executable instructions stored on a computer-readable storage medium for detecting an edge in a vector space (Y, U, V) of a color image signal as claimed in claim 43, further comprising the step of:
selecting said luminance edge as said edge in said vector space (Y, U, V) of said color image signal when said chrominance edge is located within two to four pixels of said luminance edge.
